(19) United States
(12) Patent Application Publication
(10) Pub. No.: US 2004/0021698 A1
(43) Pub. Date: Feb. 5, 2004

(54) Intuitive touchscreen interface for a multifunction device and method therefor

(76) Inventors: Amanda K. Baldwin, Winchester, KY (US); William J. Flowers, Lexington, KY (US); Charles E. Grieshaber, Versailles, KY (US); Michael R. Timperman, Versailles, KY (US); Mila M. Turbek, Georgetown, KY (US); Allen W. Waugerman, Lexington, KY (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/212,344

(22) Filed: Aug. 5, 2002

(51) Int. Cl. G09G 5/00

(52) U.S. Cl. 345/853; 345/173; 345/864; 345/841

(57) ABSTRACT

A graphical interface for a multifunction device that comprises a touch sensitive display, a system processor and a system data store. The touch sensitive display is capable of displaying graphical objects from a layer within a hierarchy of graphical objects that are representative of multifunction device operatives and of recognizing a selection of a graphical object by a user. The system processor is capable of causing a multifunction device to perform a particular operation in response to a selection of a graphical object representing that operation.

### BACKGROUND

The present invention relates to a system and method for controlling a multifunction device via a user interface. More particularly, the present invention is directed to an interface for a multifunction (MFD) device where the operations performed by the device include copying, facsimile and electronic mail operations. The invention is not limited to use with devices that provide only these functions, however, and may in some embodiments be used with devices that perform other useful functions such as document scanning and printing.

Electronic devices for performing operations such as copying, printing, scanning, faxing and transmitting documents via electronic mail are commonplace both in offices and individual homes. As these devices advance to provide an increasingly sophisticated range of functionality, the level of difficulty associated with controlling their operation increases correspondingly. Users who are not thoroughly familiar with device functionality may find it intimidating to use certain device features and shy away from these features as a result. Even a user with mastery of basic device functionality, such as making single sided copies from a single sided original, may experience frustration when attempting to use that same device to perform more complex tasks. This frustration can become even more acute in an office setting where the need to perform certain tasks is highly time sensitive and the particular user does not wish to appear incompetent. Therefore, there is a need for an intuitive user interface that allows users of varying levels of sophistication to quickly master the full range of operations of a multifunction electronic device.

### SUMMARY

In one embodiment, the present invention utilizes a touch sensitive display, or “touch screen,” to implement a user interface for controlling a device that performs multiple functions. As will be understood by those skilled in the art, a touch screen provides a display of graphical objects that are symbolic of something else. Graphical objects can include icons, text, links, action buttons, radio buttons, list boxes, navigational (up and down or back and forward) buttons, virtual keyboards, check boxes and text boxes.

A user of the device may select one or more of the graphical objects displayed on the touch screen by physically touching the display with her finger or other instrumentality, such as a stylus. The touch screen is equipped with sensors that register the touch event and generate a signal in response for delivery to a system processor for subsequent action. In some cases a software driver may be necessary to translate the signal generated by the touch screen to a signal that is recognizable by a particular system processor. Any suitable touch screen technology, such as resistive, capacitive, or surface acoustic wave type touch screens, may be used in various embodiments of the present inventions. Touch screens may use liquid crystal display (LCD), cathode ray tube (CRT), plasma screen or other type monitors. The interfaces according to the present invention, however, are not directed to any particular touch screen hardware configuration or architecture, and may be used with touch screens and monitors of any type. Likewise, the present invention is not limited to use in connection with an MFD with any particular combination of operational capabilities.

The present invention, in some embodiments, utilizes a system processor and a data storage component to present an MFD user with a touch screen display of graphical objects that represent the operational features of the MFD. Graphical objects that allow the user to navigate the plurality of displays within the user interface are also provided. The invention provides in some embodiments a hierarchal presentation of graphical object displays that separate basic functions from their more complex or seldom used derivatives. Pathways across the various displays of graphical objects are clearly indicated to allow quick and intuitive navigation of the user interface and use of the MFD by users having varying levels of skill.

The user interface presents the user with graphical objects designed to convey pictorially the operation the MFD will perform if a particular graphical object is selected and its corresponding function is enabled. The touch screen presents the graphical objects in color and cognitively groups them to facilitate user comprehension.

In its idle state the touch screen in one exemplary embodiment displays a separate graphical object for each function of the MFD. In one such embodiment these functions include copy, facsimile and electronic mail operations. Selection of a fax icon leads the user to the primary fax display screen, where the user can choose to utilize only basic facsimile features or to select other more advanced fax features. These advanced features may include edge erase or performing a search of contact information such as fax numbers. Selection of the electronic mail or copy icons similarly leads the user to a primary display, where the user may choose between utilizing basic functionality or more advanced options. A traditional keypad of hard buttons may be used in conjunction with the touch screen. In all cases “exits,” which lead the user back to a previous screen from a display of advanced options, are clearly marked to intuitively lead the user to the correct destination. Accordingly, one exemplary method of controlling a multifunction device via a graphical user interface according to the present invention includes a variety of steps that may, in certain embodiments, be executed by the environment summarized above and more fully described below or be stored as computer executable instructions in and/or on any suitable combination of computer-readable media.

Additional advantages of certain embodiments of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain the principles of the invention.

FIG. 1 illustrates a touch sensitive display of graphical objects with a keypad of hard buttons.

FIGS. 2 and 2A illustrate an entry level display of graphical objects that represent copying operations.

FIG. 3 illustrates a display of graphical objects from a hierarchy of graphical objects that represent various advanced copying operations.

FIG. 4 illustrates a display of graphical objects from a hierarchy of graphical objects that represent advanced duplex type copying operations.

FIG. 5 illustrates a display of textual information regarding the advanced duplex operation.

FIG. 6 illustrates a display of graphical objects that represent paper sizes for copying operations.

FIGS. 7 and 7A illustrate a display of graphical objects that relate to facsimile operations.

FIGS. 8, 8A and 8B illustrate displays of graphical objects from a hierarchy of graphical objects that represent facsimile operations.

FIGS. 9, 9A and 9B illustrate a virtual keyboard display utilized to search a collection of facsimile related contract information.

FIGS. 10, 10A, 10B, 10C and 10D illustrate various displays of graphical objects within a hierarchy of graphical objects that relate to electronic mail operations.

FIG. 11 illustrates a display of graphical objects that relate to an account tracking feature of one embodiment of the present invention.

FIG. 12 illustrates a display of graphical objects that relate to a profile feature of one embodiment of the present invention.

### DETAILED DESCRIPTION

Exemplary embodiments of the present invention are now described in detail. Referring to the drawings, like numbers indicate like parts throughout the views. For ease of explanation, the description below is at various places directed to a multifunction device that performs operations related to copying, electronic mail, facsimile and document scanning. It will be appreciated, however, that the invention may also be applicable to use with devices that perform other document or communication related functions. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context clearly dictates otherwise.

One exemplary embodiment includes a system processor, a system data store, and a touch sensitive display monitor. The system processor may include one or more general-purpose system processors such as an Intel 80386, 80486 or PENTIUM family of system processor (Intel Corp., Santa Clara, Calif.). Alternatively, or additionally, the system processor can include one or more special purpose processors such as one or more FPGA or ASIC elements with or without hard coded logic that performs the MFD control processes according to one embodiment of the present invention. Further, the system processor can include a combination of processing elements including general-purpose and/or special purpose processors. The term processing element may refer to (1) a process running on a particular piece, or across particular pieces, of hardware, (2) a particular piece of hardware, or either (1) or (2) as the context allows. In some embodiments, processes may be spread across multiple processing elements.

The interface may include a system data store (SDS) (not shown). The SDS could include a variety of primary and secondary storage elements. In one exemplary embodiment, the SDS would include RAM as part of the primary storage although the amount of RAM may vary depending upon the level of functionality with which the invention is implemented, a typical implementation can include 128 MB of RAM; however, this amount can vary significantly by implementation. In addition to, or instead of, RAM memory, some embodiments may include writeable non-volatile memory such as FLASH memory; in one exemplary embodiment, the amount of FLASH memory is 512 KB; however, other embodiments can include more or less FLASH memory and/or use other types of memory in addition to, or exclusive of, such FLASH memory. The primary storage may in some embodiments include other forms of memory such as cache memory, registers, non-volatile memory (e.g., ROM, EPROM, etc.), etc.

The SDS may also include secondary storage including single, multiple and/or varied servers and storage elements. It will be understood by those skilled in the art that the different information used in the system according to one embodiment of the present invention may be logically or physically segregated within a single device serving as secondary storage for the SDS; multiple related system data stores accessible through a unified management system, which together serve as part of the SDS; or multiple independent system data stores individually accessible through disparate management systems, which may in some embodiments be collectively viewed as part of the SDS. Such stored information may include graphical objects and related information, contact information and/or authentication information (passwords, user names or other information used to restrict access). The various storage elements that comprise the physical architecture of the SDS may be centrally located, or distributed across a variety of diverse locations. The storage elements may include one or more standard magnetic and/or optical disk drives using any appropriate local interface (e.g., IDE and SCSI) or network-based file system interface.

The architecture of the secondary storage of the system data store may vary significantly in different embodiments. In several embodiments, database(s) may be used to store and manipulate the data; in some such embodiments, one or more relational database management systems, such as DB2 (IBM, White Plains, N.Y.), SQL Server (Microsoft, Redmond, Wash.), ACCESS (Microsoft, Redmond, Wash.), ORACLE 8i (Oracle Corp., Redwood Shores, Calif.), Ingres (Computer Associates, Islandia, N.Y.), MySQL (MySQL AB, Sweden) or Adaptive Server Enterprise (Sybase Inc., Emeryville, Calif.), may be used in connection with a variety of storage devices/file servers that may include one or more standard magnetic and/or optical disk drives using any appropriate interface including, without limitation, IDE and SCSI. In some embodiments, a tape library such as Exabyte X80 (Exabyte Corporation, Boulder, Colo.), a storage attached network (SAN) solution such as available from (EMC, Inc., Hopkinton, Mass.), a network attached storage (NAS) solution such as a NetApp Filer 740 (Network Appliances, Sunnyvale, Calif.), or combinations thereof may be used. In other embodiments, the system data store may use database systems with other architectures such as object-oriented, spatial, object-relational or hierarchical.

Other embodiments may use other storage implementations such as hash tables or flat files or combinations of such architectures. Such alternative approaches may use data servers other than database management systems such as a hash table look-up server, procedure and/or process and/or a flat file retrieval server, procedure and/or process. Further, the SDS may use a combination of any of such approaches in organizing its secondary storage architecture.

Any suitable touch screen can be used in implementing the interfaces. The touch registration technology can be of any known type including, without limitation, resistive, capacitive, or surface acoustic wave type touch screens. Any suitable type of monitor can be incorporated in the touch screen; such types can include liquid crystal display (LCD), cathode ray tube (CRT), plasma screen or other monitor type suitable for displaying graphical object. As will be understood by those skilled in the art, any appropriate touch screen technology capable of rendering the interface can be used.

Both the SDS and touch screen communicate with the system processor via one or more communication channels. The SDS, or elements thereof, and touch screen can use the same communication channel such as a local bus or use different channels. In some embodiments, various elements of the SDS can communication with the system processor, or elements thereof, via different communication channels; for instance, the system processor, or one or more elements thereof, can communicate with primary storage using one channel such as a local bus whereas communication with secondary storage can use a second channel such as a computer network, a serial or parallel connection, a USB connection, a dial-up connection or other suitable conduit.

Various methods and functions as exhibited in various embodiments according to the present invention are described below. In some embodiments, one or more system processors within architectures of the environments as described above may execute the steps in such methods and provide such functionality. The functionality may spread across multiple processing elements; in certain embodiments, these processing elements may logically and/or physically be divided into access, compliance logic and data storage processing elements where functionality is allocated appropriately among such processing elements. In other embodiments, any suitable computer readable storage device, including primary storage such as RAM, ROM, cache memory, etc. or secondary storage such as magnetic media including fixed and removable disks and tapes; optical media including fixed and removable disks whether read-only or read-write; paper media including punch cards and paper tape; or other secondary storage as would be known to those skilled in the art, may store instructions that upon execution by one or more system processors cause the one or more system processors to execute the steps in such methods and to provide such functionality.

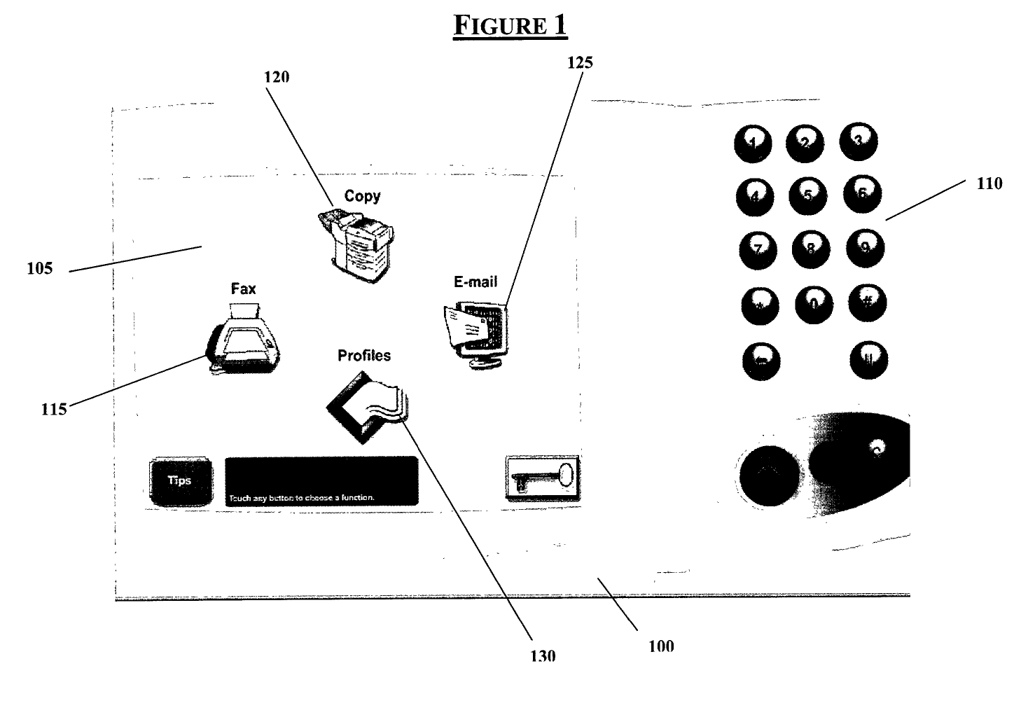

FIG. 1 illustrates a user interface 100 with a touch sensitive display screen 105 and a keypad 110 of “hard buttons.” In other embodiments, the keypad 110 may be implemented as part of touch sensitive display 105. The display 105 may, in some embodiments, include a display monitor covered with a separate touch screen. Alternatively, the display monitor and touch screen may be an integrated unit. Touch sensitive display 105 can be implemented through a variety of known touch screen technologies, including resistive, capacitive, and surface acoustic wave type touch screens. As is understood in the art touch screens may be used with different types of display monitors including liquid crystal display (LCD), cathode ray tube (CRT), plasma screen or other type monitors.

Touch sensitive display 105 displays numerous graphical objects. Graphical objects are symbolic of some operation, or the result of an operation, that can be performed by the multifunction device. Graphical objects can include icons, text, links, action buttons, radio buttons, list boxes, check boxes, text boxes, navigational buttons, virtual keyboards and the like.

Graphical objects are ideally intuitive in nature. A graphical object displayed on touch sensitive display 105 is symbolic of a particular multifunction device operation and pictorially conveys information about that operation to the user. A user selection of copy icon 120 will cause the user interface to display the first level of graphical objects in the hierarchy of graphical objects that relate to copying operations performed by the multifunction device. Likewise, user selection of fax icon 115 or email icon 125 leads the user to a first level user interface display relating to facsimile and electronic mail operations, respectively.

The profiles icon 130 is present on the screen to allow a user to access a display of graphical objects that represent default preferences or instructions relating to the performance of particular multifunction device operations. Examples of these operations include the following: electronic mail, facsimile and FTP distributions; changing document scan information; printing information received by the multifunction device; converting scanned items into text documents; capturing information entered by the user via the user interface of the present invention and entering that information into form documents such as portable document format (PDF) form, distributing or printing form documents, manipulating bar codes on documents, storing information in databases; authenticating users within a database, delivering images to folders in a particular computer, and deciding which of a plurality of prompts or paths or forms to use based upon user input. Information relating the profiles feature may be stored in the system data store or received from a remote source via a network. In a exemplary embodiment, the profiles feature may be used with any one of the above listed operations or with any combination of these or other operations described herein.

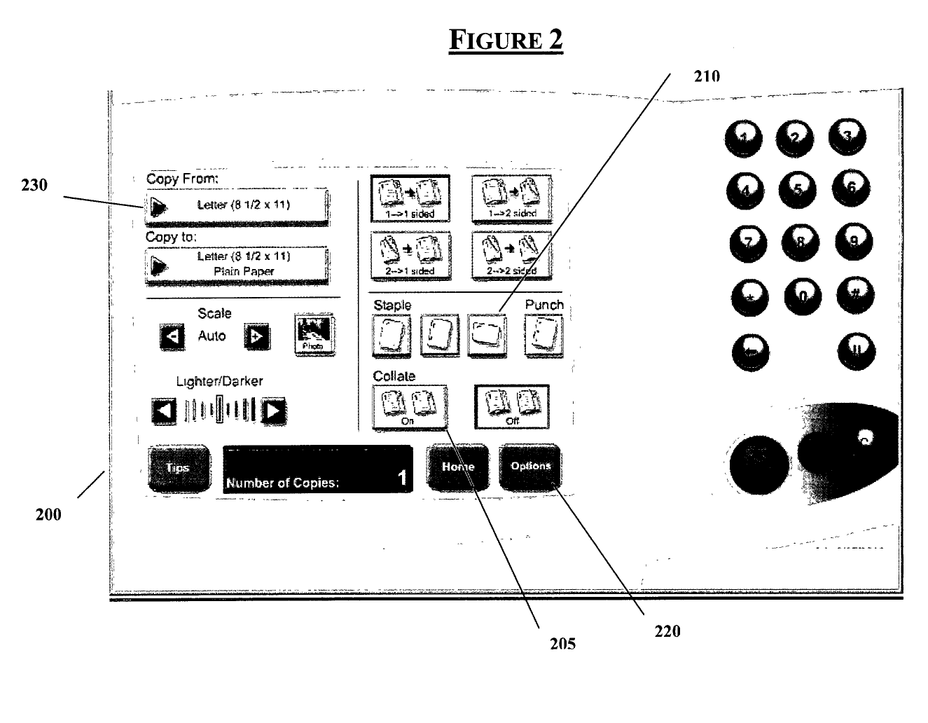

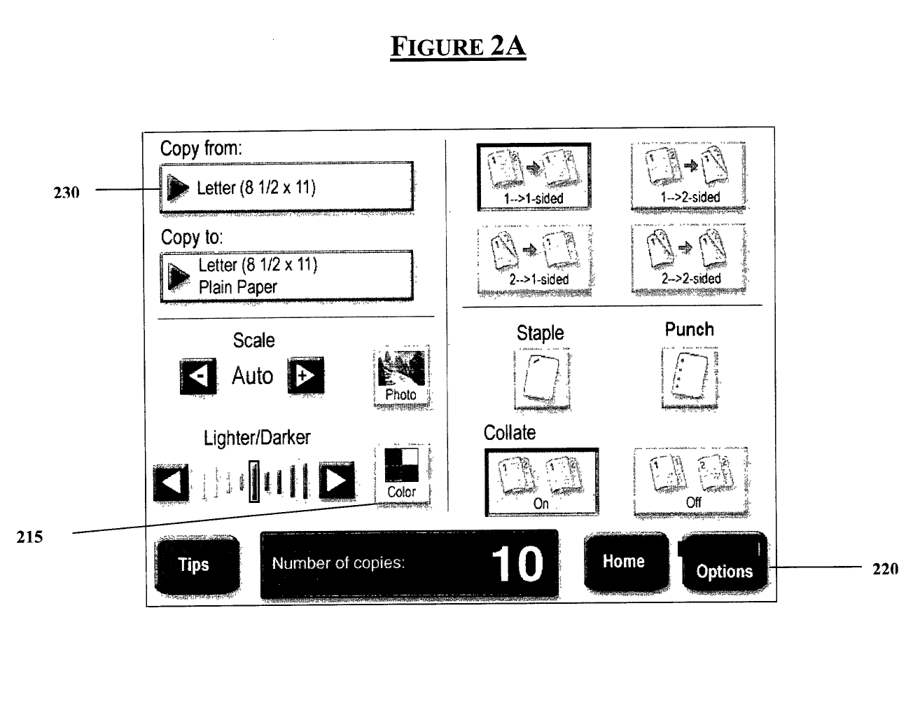

FIG. 2 illustrates an exemplary embodiment of an initial display 200 of graphical objects that are presented to a system user upon selection of the copy icon 120 from the touch sensitive display 105. Multiple graphical objects that relate to a particular parameter of the copy operation are arranged into cognitive groupings. These cognitive groupings utilize a system user's experience and observations to convey information regarding operation of the multifunction device or navigation of the hierarchy of graphical objects. Use of cognitive grouping of icons may be repeated across other layers of graphical objects within the graphical object hierarchy, as will be apparent to one of skill in the art from examination of the attached figures.

FIG. 2 depicts what can be described as “basic” copying functions for purposes of explanation. From the display, the user can configure a copy job according to paper size, image scale, lightness or darkness, stapling preferences, hole punch preferences, whether the copies will be collated or not, as well as other options. Each of these options are visually depicted by graphical objects such as icons and accompanying text or action buttons.

The collate function “on” icon 205 visually conveys the concept of collating documents. Likewise, the staple icon grouping 210 pictorially depicts the fashion in which copies would be stapled upon selection of a particular icon. The display 200 can be configured with additional or fewer graphical objects as needed to suit the particular capabilities of a given device.

FIG. 2A illustrates a further embodiment of a graphical interface display for a device with more limited stapling functions but with color copying operations as indicated by color icon 215. As is readily seen, the graphical objects representing the copying operation parameters in FIGS. 2 and 2A provide an ordinary user with an intuitive and easy to understand range of control over the copying operations performed by the multifunction device. In some cases, an ordinary user or a more sophisticated user may have need of more sophisticated copying operations. In this circumstance selection of the action button 220 labeled “Options” would take that user to a subsequent display in the copy hierarchy where additional graphical objects would be presented.

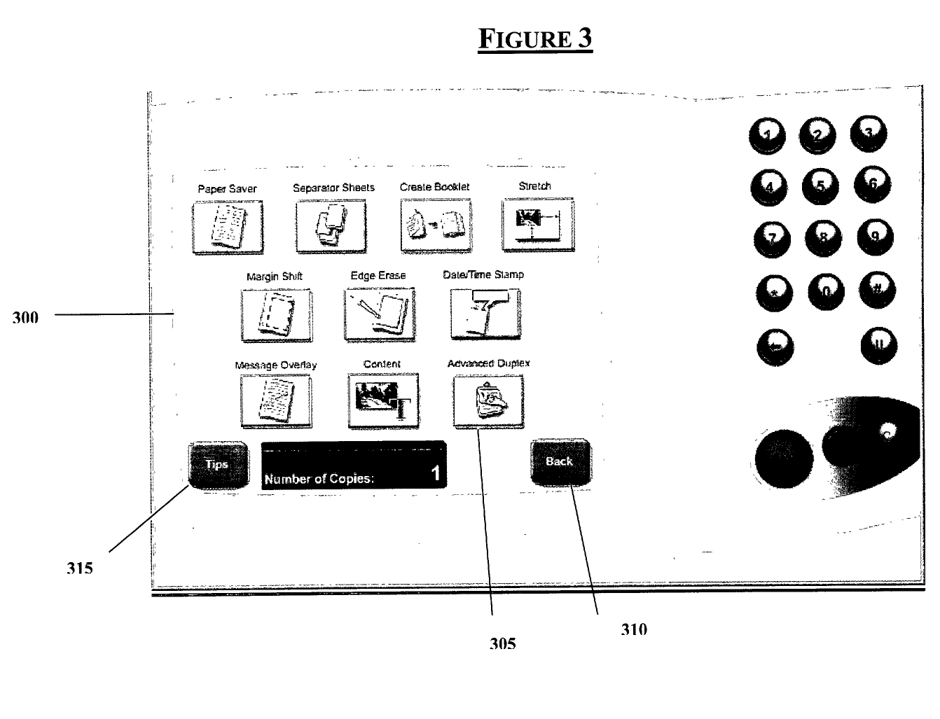

FIG. 3 depicts a display screen 300 in one exemplary embodiment with graphical objects that would be presented to the user upon selection of the Options button 220 from the initial display screen 200 of FIG. 2. The graphical objects presented in display screen 300 are exemplary of copy job parameter functions that may be considered “complex” in that they may not be the most commonly used and therefore may be beyond the understanding of the novice or ordinary user. As before, graphical objects presented in display 300 are designed to pictorially convey information regarding the copying operation that will be performed by the multifunction device upon user selection of that graphical object.

The advance duplex icon 305 will now be discussed as an example. The term “advance duplex” may not have meaning to many casual users of the copying operation of the multifunction device. However, the icon 305, which represents the entry point to the graphical interface display of the advanced duplex operation, can quickly convey the purpose of this feature.

In addition to graphical objects that represent complex copying operations, FIG. 3 also provides an illustration of the navigational aspects of graphical objects. Back button 310 will allow the user to easily return to the previous screen if she entered this display by accident. A user may easily navigate from display to display, thus navigating a control pathway from basic device operation to a more complex operation in the process. Furthermore, the tips button 315 can be selected to lead a user to a textual explanation of a particular operation of the multifunction device.

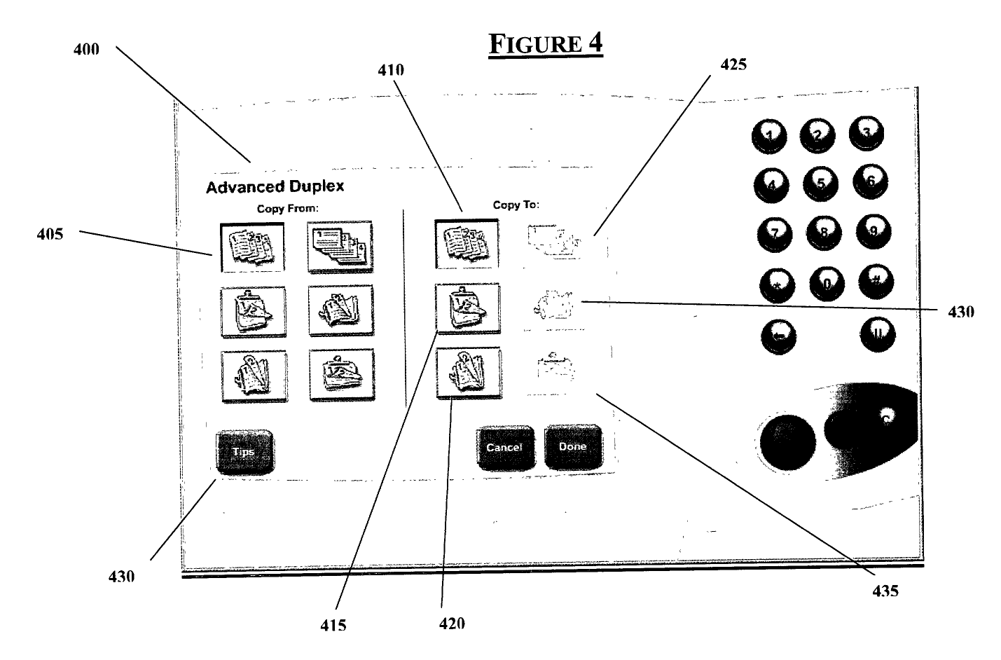

FIG. 4 illustrates a display screen 400 that presents an embodiment of graphical objects contained in the copy hierarchy that are presented in response to the selection of the advanced duplex graphical object 305. A user presented with display 400 can readily ascertain the significance of selecting one advanced duplex option over another based on the visual information delivered to her via the graphical objects. For example, selection of graphical object 405, which represents single sided originals in portrait orientation, followed by a subsequent selection of graphical object 410 (also single sided portrait documents) immediately causes the user to understand what the result of the copying operation will be. The user can similarly select graphical objects 415 or 420 to produce two-sided copies of varying portrait orientations from a set of single-sided originals.

Further intuition is gained from the fact that the set of graphical objects 425, which represent landscape orientation documents, are grayed out. The graying out of certain graphical objects makes it apparent to the user that certain duplex options are not available for use in particular combinations. In this example, the MFD cannot produce two-sided copies of landscape orientation as depicted in graphical objects 425, 430 and 435 from single sided originals in portrait orientation as shown by graphical object 405. Altering the initial selection from graphical object 405 can cause the set of compatible original and copy formats to change, which in turn changes the set of graphical objects that are grayed.

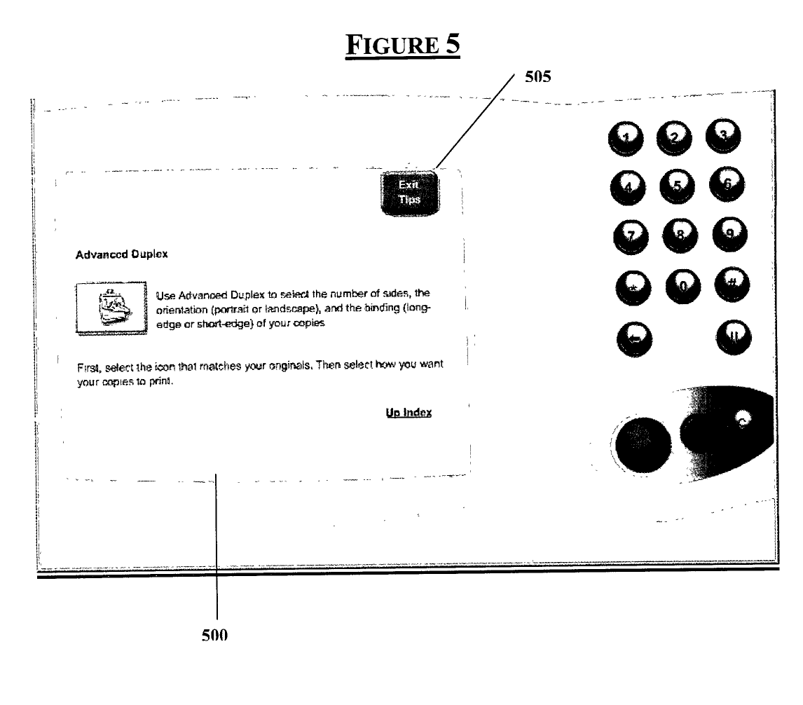

A system user who is relatively unfamiliar with duplex functionality may still not be comfortable with the representation or information conveyed by the graphical objects of display. Some embodiments may therefore include a tips button 430. User selection of tips button 430 will provide the user with additional information as is shown in FIG. 5.

FIG. 5 illustrates a display 500 that provides the user with further information concerning advanced duplex operations. As will be apparent to one of skill in the art, graphical objects such as the tips button 430 may be included on any display of graphical objects to provide information to a user as appropriate. The presence of Exit Tips button 505 allows the user ease of navigation into and out of the tips screen. In general, graphical objects that provide the user with an easily recognizable exit from a particular graphical interface display may also be placed on any display.

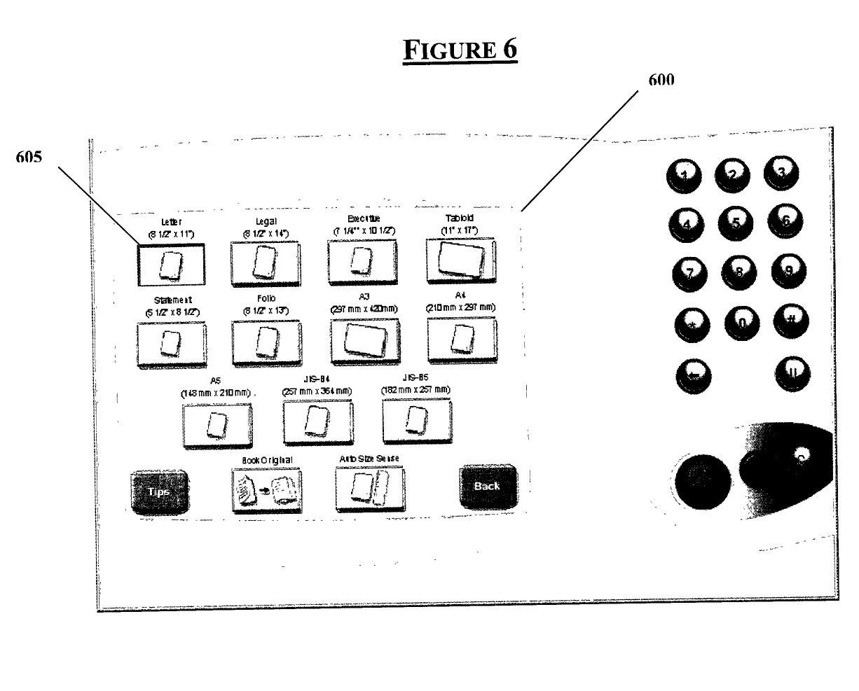

FIG. 6 illustrates one exemplary embodiment of a display 600 of paper sizes from which the system user may select when executing various copying operations. The screen is accessed upon selection of graphical object 230 from display screen 200 in FIG. 2. FIG. 6 also provides an illustration of alternative pathways within a hierarchy of displays from an initial or basic interface. Display 200 allows access to a plurality of displays screen with graphical objects that represent expanded or more complex derivatives of the MFD copy operation. The particular sequence of the hierarchy is adaptable to address prevailing usability issues, and the hierarchy for a particular operation may contain alternative navigation pathways. Each available size of paper stock, such as 8½×11 inch letter size paper as represented by graphical object 605, are presented to the user who readily understands the range of paper sizes that are available. A user may already be aware of how to change a common paper size such as 8½″×11″, however something less common such as JIS-B4 may make an otherwise simple task feel more complicated. Upon selection, graphical object 605 is altered in appearance by changing its color or dimension or other physical characteristic.

Change in appearance of a graphical object in response to user selection may be common across all user interface display screens and is illustrated in multiple Figures, including FIG. 6. Appearance changes may include altering the color scheme of the graphical object itself on a border surrounding the graphical object, changing the shading or the graphical object or altering the shape or structure of the graphical object.

Collectively FIGS. 2 through 6 illustrate how a user may navigate the user interface to access control over copying operations of varying breadth and complexity. It will be understood that the intuitive nature of each screen, including common color schemes, grouping of graphical objects, visual cues or audible signals, can be repeated across displays that pertain to any range of device operations or user interface navigation. For purposes of further explanation, exemplary display screens that present graphical objects for additional device functionality are discussed in the following paragraphs of this specification.

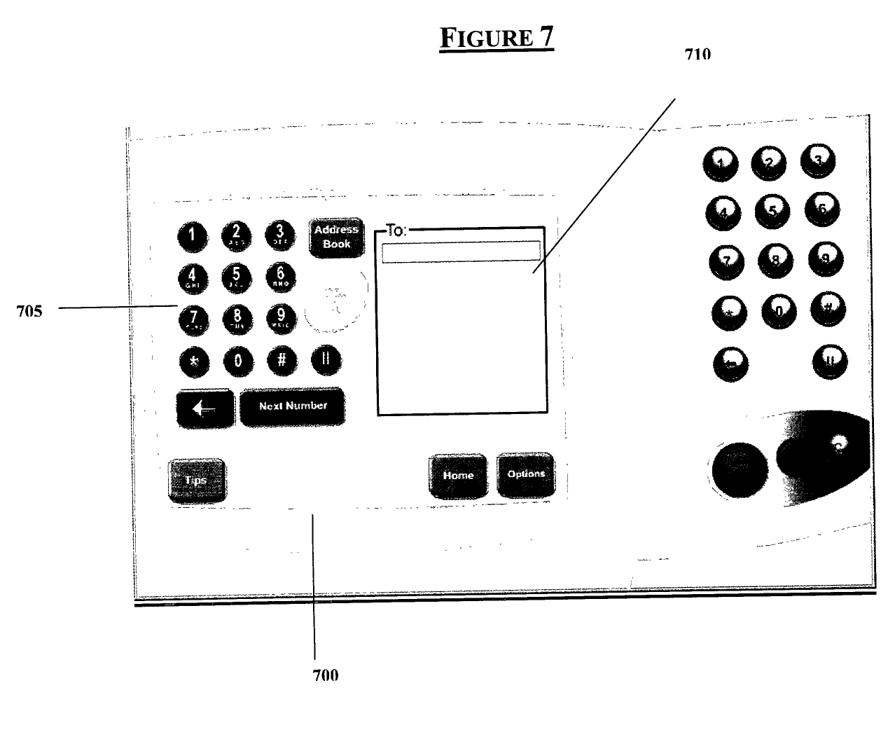

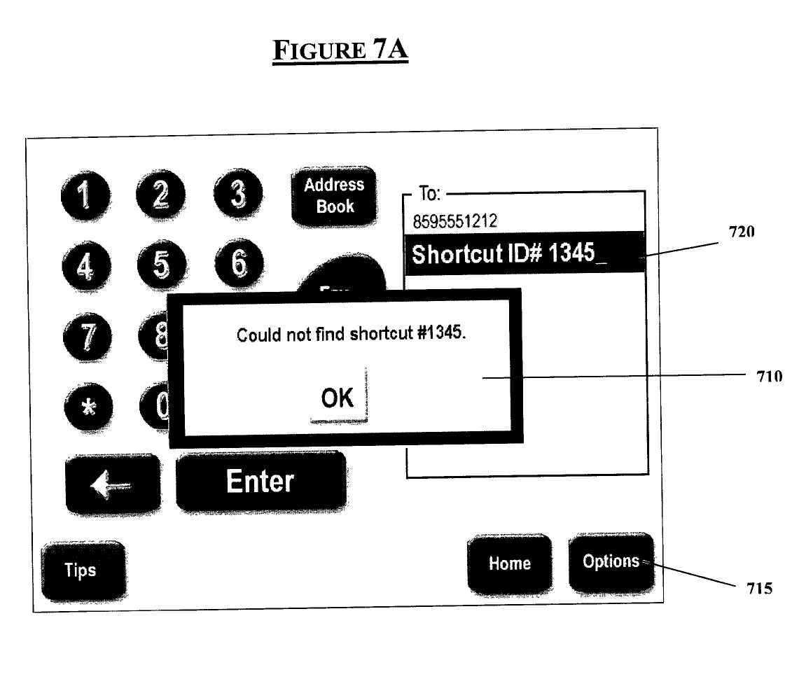

FIG. 7 illustrates a display 700 that is presented to the user in one exemplary embodiment upon selection of the fax icon 115 from display screen 100. The display 700 is composed of a keypad 705 having a variety of graphical objects and a textbox 710 labeled “To:” into which the fax number of the intended recipient(s) may be entered. Touching various ones of the numeric soft keys causes a corresponding entry to appear in textbox 710.

In one embodiment of the present invention, the user may choose to enter a full fax number for the destination fax machine, such as is depicted in display 700. Alternatively, or in addition the user may enter an abbreviated representation of the destination fax number, as is depicted by shortcut ID#1345 in FIG. 7A. A shortcut identification corresponds to a particular person or organization, most likely a frequent recipient of facsimile transmissions from the present operator of the system. As is shown in FIG. 7A entry of a particular shortcut identification may cause the system to attempt to retrieve the full contact information needed to send a facsimile to the intended recipient. In the event the contact information cannot be located the user may in certain embodiments be presented with an error message via a dialog box 710. Certain embodiments may use error dialogs as appropriate in any other display screen of a user interface according to the present system: Selection of options button 715 will lead the user to a subsequent display screen containing a layer of graphical icons in the hierarchy that represent facsimile related functionality.

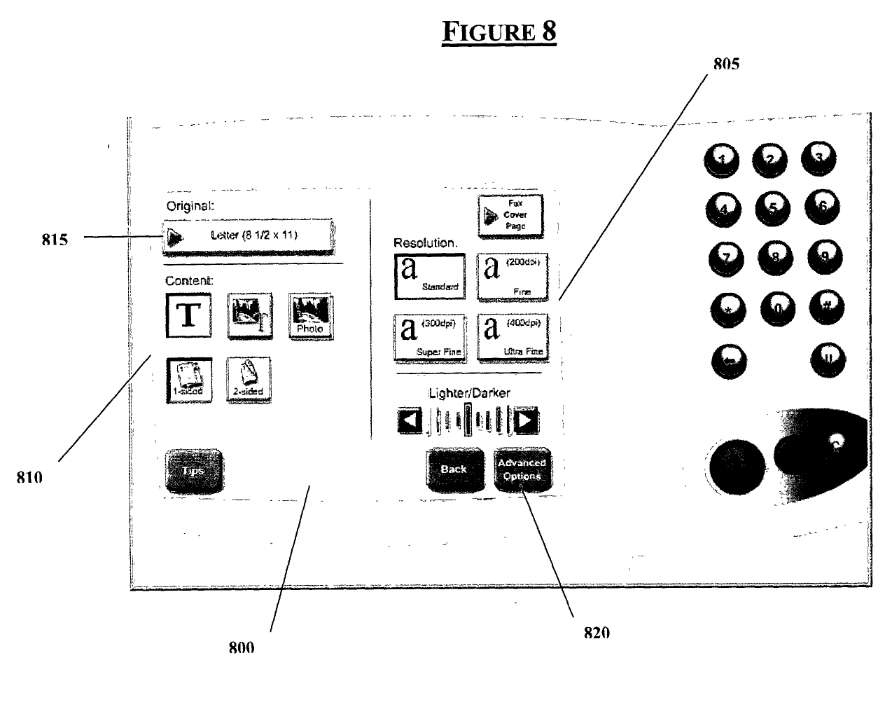

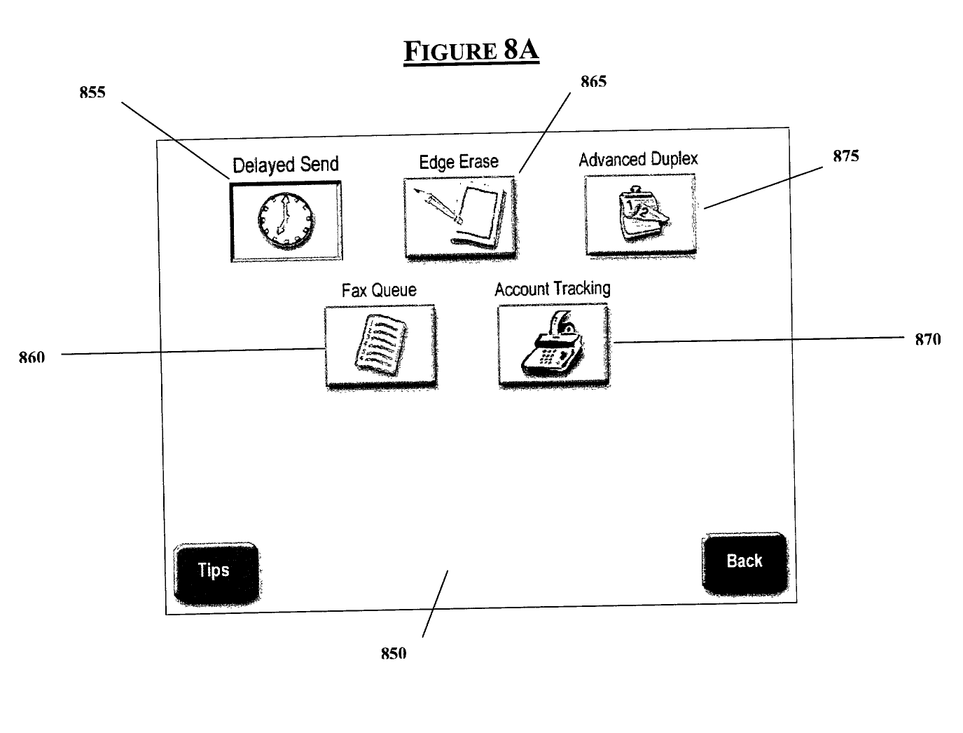

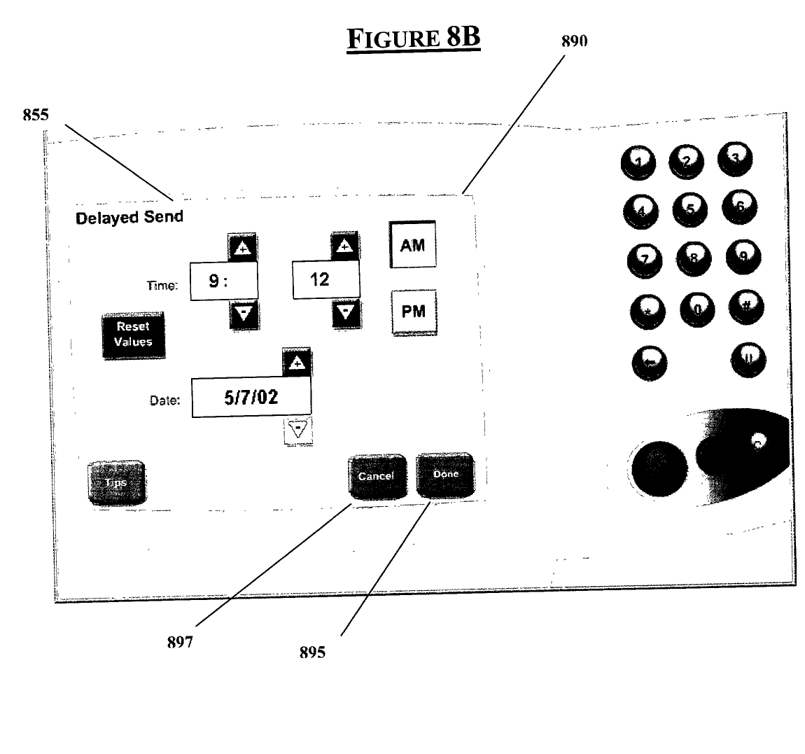

FIG. 8 illustrates the display 800 in one exemplary embodiment of graphical objects associated with a layer of facsimile functionality, such as is accessible by selecting options button 715 from display 700, that is considered to be basic facsimile functionality. Graphical object groupings 805, 810 and 815 relate to the resolution, content (text or text and image, as well as page orientation) and original paper size associated with the facsimile function to be performed. The user may select from one or more of these graphical object groupings as appropriate or the user may elect to invoke more advanced facsimile operations by selecting the advanced button 820. FIG. 8A illustrates the advanced options that could be presented to a user in one embodiment on display screen 850. In this embodiment, these options include delayed send represented by on graphical object 855, fax queue represented by graphical object 860, edge erase as represented by graphical object 865, account tracking as represented by graphical object 870 and advanced duplex as represented by graphical object 875. It will be understood that graphical objects can be added or deleted from this or other screens as needed to convey the appropriate range of functionality of a particular MFD.

As with the other screens, selecting any of these graphical icons will again lead the user to a display screen with additional options related to the particular functionality selected. The interface can allow the user to exercise control over any aspect of facsimile operations, including the creation of a cover sheet that reflects the identity of the sender and a message. By way of example, selecting delayed send icon 855 may lead the system user to a display screen such as depicted in FIG. 8B, display screen 890 provides all options needed to specify a number of days, hours and minutes by which to delay the transmission of the facsimile communication. When the user is finished specifying these parameters, she may click the done button 895 and return or may cancel the operation all together, via button 897.

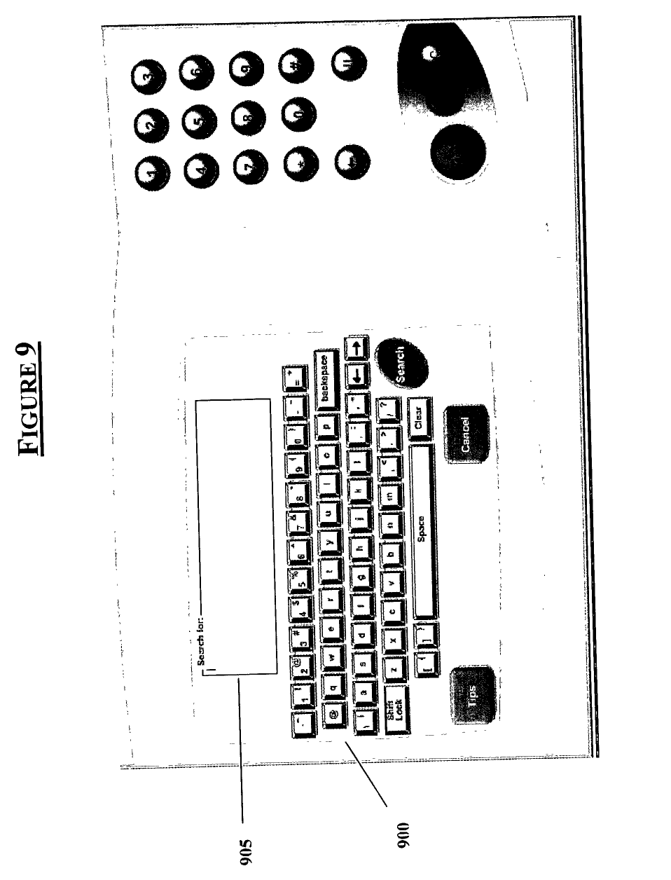

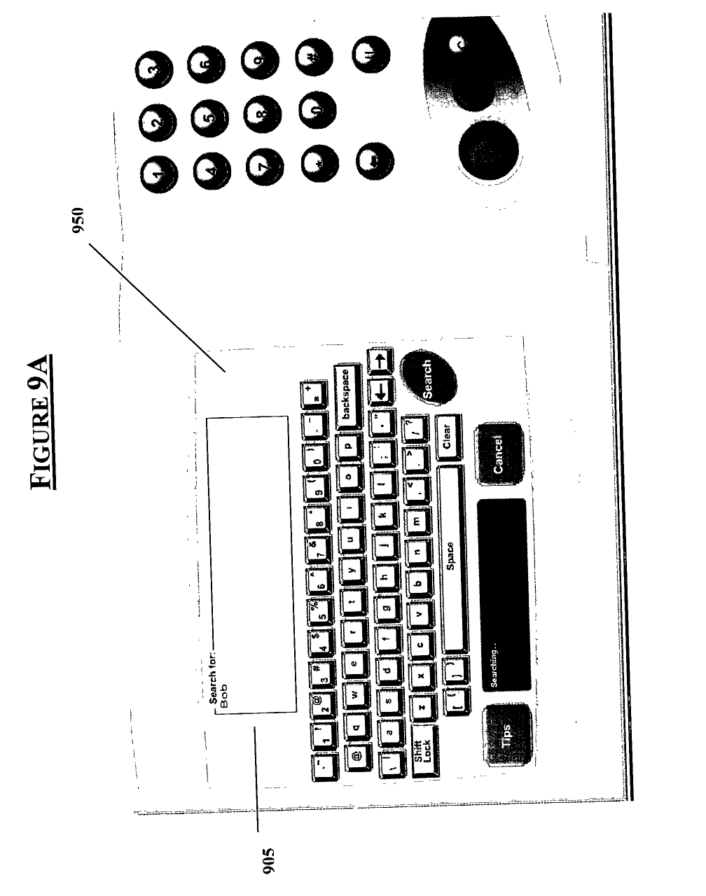

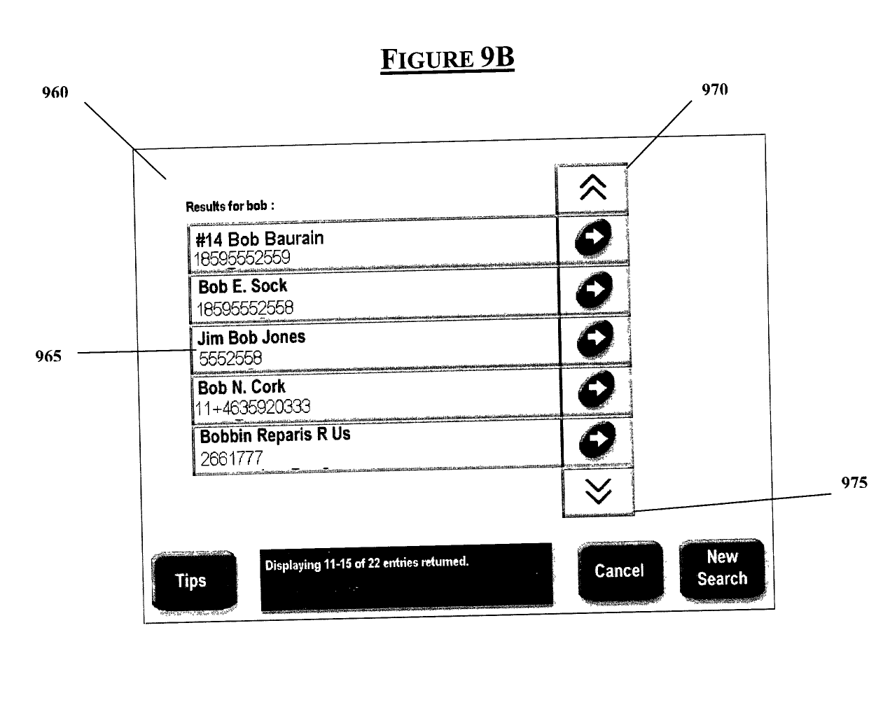

FIG. 9 illustrates an interface screen 900 for sorting, searching, retrieving or otherwise manipulating contact information stored in an associated system data store for potential recipients of MFD output. FIG. 9 provides an exemplary interface screen 900 that may be used in one embodiment. For purposes of explanation, the search feature will now be discussed.

The virtual keyboard of display 900 can itself be a graphical object or each individual representation of a key can be its own graphical object. Selecting a key of the virtual keyboard in display 900 causes the character corresponding to that key to appear in the text box 905 at the top of the display 900. By entering part or all of the name of an intended recipient, the system will search the stored contact information for contacts that correspond to the search term.

FIG. 9A illustrates the display 950 presented to the system user after the search term “Bob” has been entered using the virtual keyboard. FIG. 9B illustrates display 960, which has returned a subset of matches for search term “Bob”. By selection of graphical object 965, the user can cause the contact information for Jim Bob Jones to be registered as a destination for the facsimile transmission. If necessary, the user may select graphical objects 970 and 975 to page up or page down through prior or subsequent listings in the search results that also match the search term “Bob”.

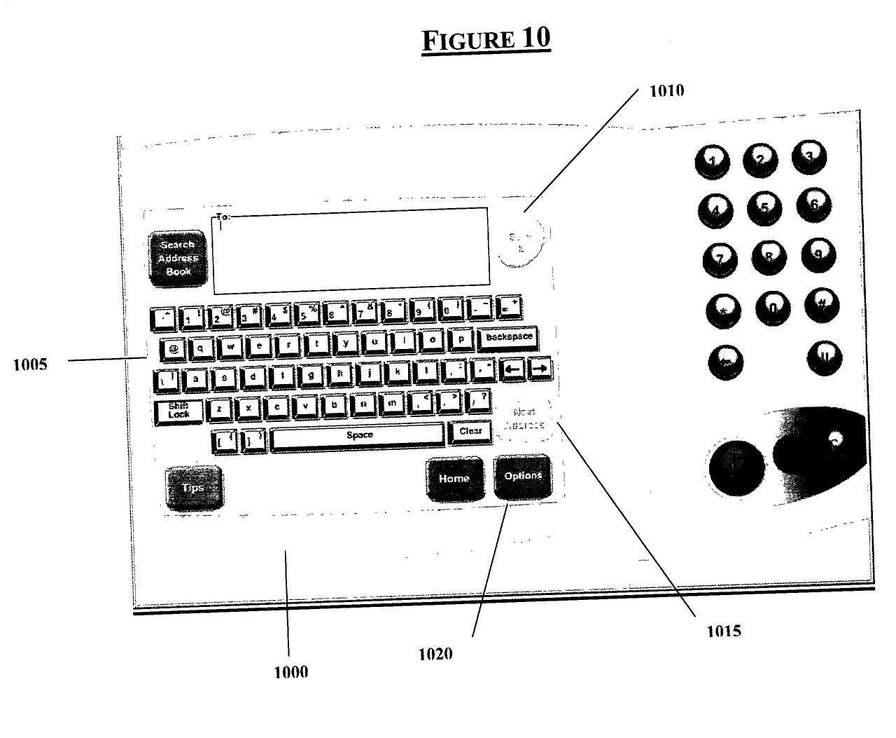

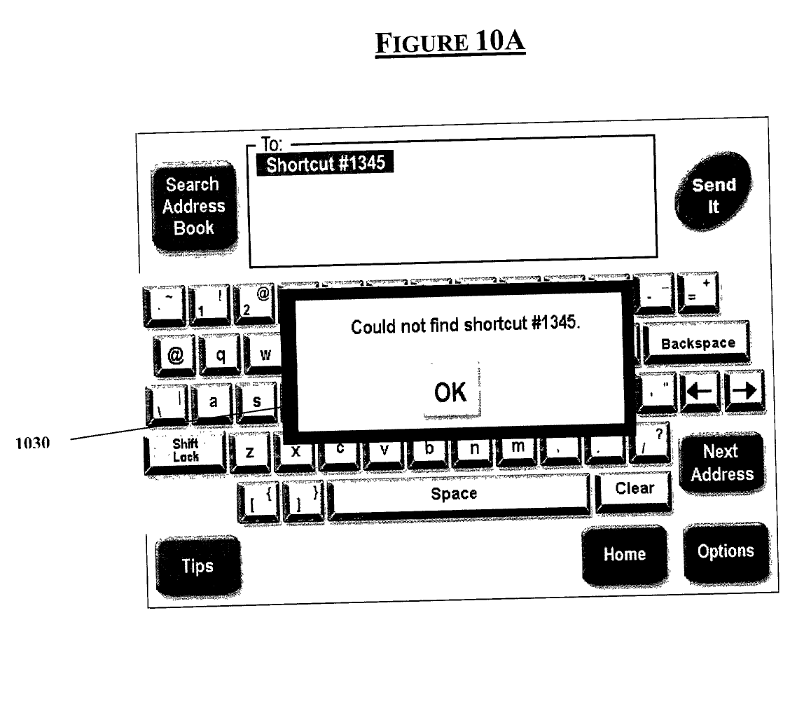

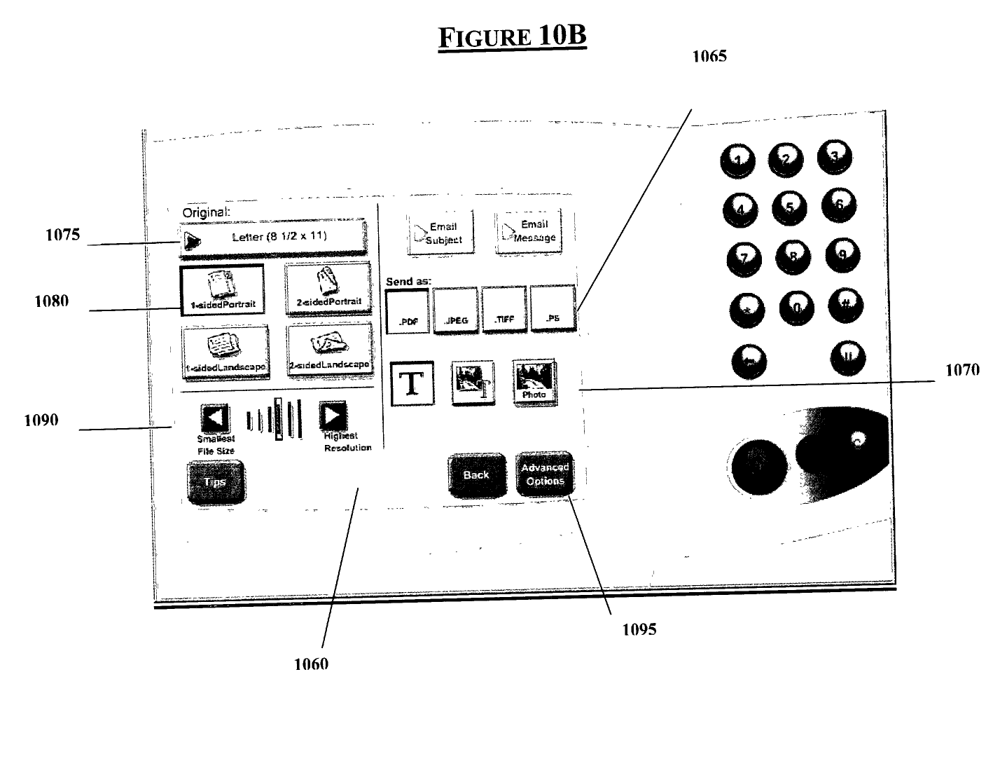

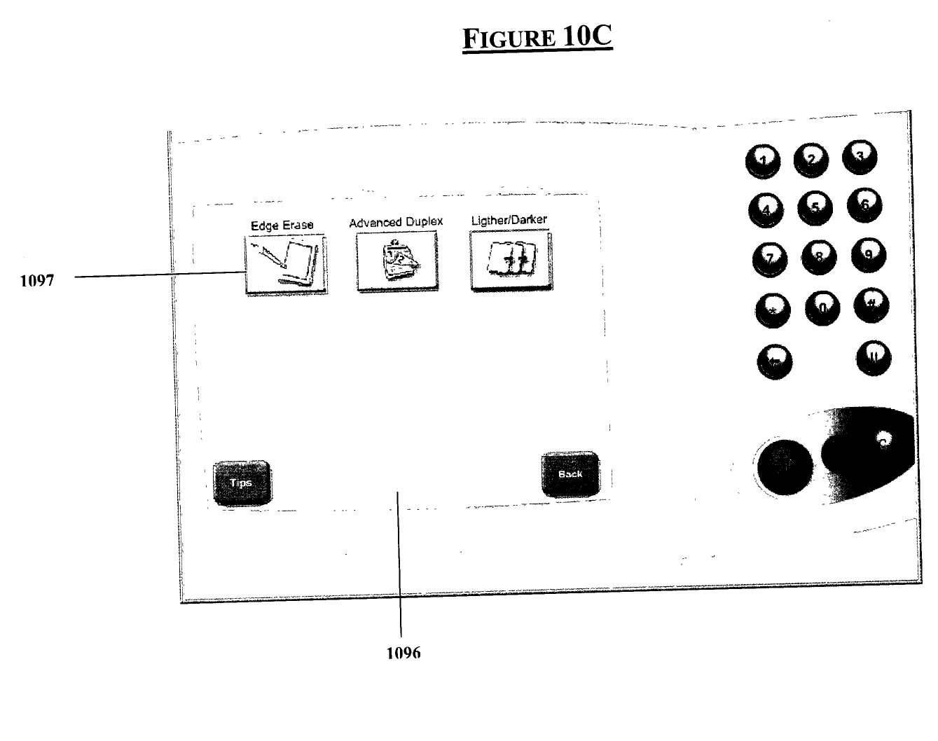

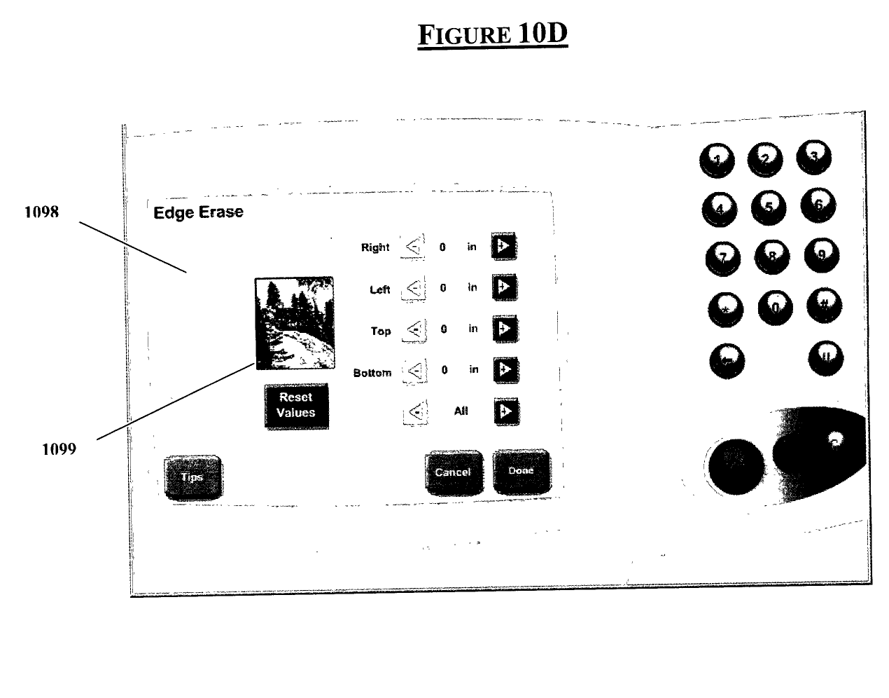

FIG. 10 illustrates an entry display for the electronic mail functionality, which can be presented to the user upon selection of the email icon 125 of display 100. Display 1000 is occupied by various graphical objects, including, a virtual keyboard 1005 and action buttons. The user has multiple options upon entering Display 1000, including accessing more advanced central parameters or searching a collection of contact information for potential recipients of an electronic mail message. In its initial state, display 1000 has grayed out the “send-it” button 1010 and the “next address” button 1015. Both of these buttons will be activated upon the entry via keyboard 1005 of a suitable electronic mail address.

Virtual keyboard 1005 may also used to enter subject and message information. The graphical interface of one embodiment of the present invention may utilize shortcut keys for electronic mail operations in a fashion similar to that of facsimile operations controls. By entering a shortcut identification number the corresponding contact information will be retrieved from the information stored in an electronic memory, whereupon it can be used to deliver the electronic mail message. Shortcut functionality is illustrated with respect to electronic mail operations in FIG. 10A. As with facsimiles operations the inability of the system to locate contact information corresponding to a particular shortcut identification number will, in one embodiment, result in the presentation of error dialog 1050.

FIG. 10B illustrates a display 1060 in one embodiment with graphical objects representing functions that could be described for purposes of explanation as basic electronic mail operations. This display is accessible by selecting “options” button 1020 from the electronic mail entry display screen 1000. Electronic mail operations may include utilizing the multifunction device to send an electronic mail message alone or an electronic mail message with an electronic copy of a document imbedded or attached. Graphical icon groupings 1065 represent various file formats of the document copy from which the user may select. The file formats illustrated are illustrative only and the present invention is not limited to use with any particular file format.

Graphical icon groupings 1070 allow the user to pick the type of document that will be sent, such as a text document or a text document with an image or photo included, and whether that image or photo will be in color or in gray scale. Graphical icon groupings 1075 and 1080 allow the user to specify the type of paper stock on which the original document is printed as well as duplex parameters, respectively. Graphical objects 1090 allow the user to specify the document resolution and thus the size of the document file. Should the user wish to pursue more advanced operations relating to the electronic mail functionality, then advanced options button 1095 may be selected.

FIG. 10C illustrates display 1096 that provides the system user with various advanced options including, edge erase, advanced duplex, lightness or darkness. Selection of a graphical option can result in the presentation of a display screen with additional graphical objects that represent controls relating to that particular operation. By way of example, FIG. 10D illustrates a display screen 1098 of graphical objects accessible by selecting “edge erase” button 1097. Display 1098 presents the user with multiple options for manipulating an electronic copy of a document. In an exemplary embodiment, picture 1099 dynamically changes with the manipulation of the “plus” and “minus” buttons situated along the right edge of display screen 1098. Repeated user selection of a “plus” button will cause an increasing section of the corresponding edge of picture 1099 to be overwritten in gray. Likewise, selection of a “minus” button will cause the appropriate portion of picture 1099 to reappear.

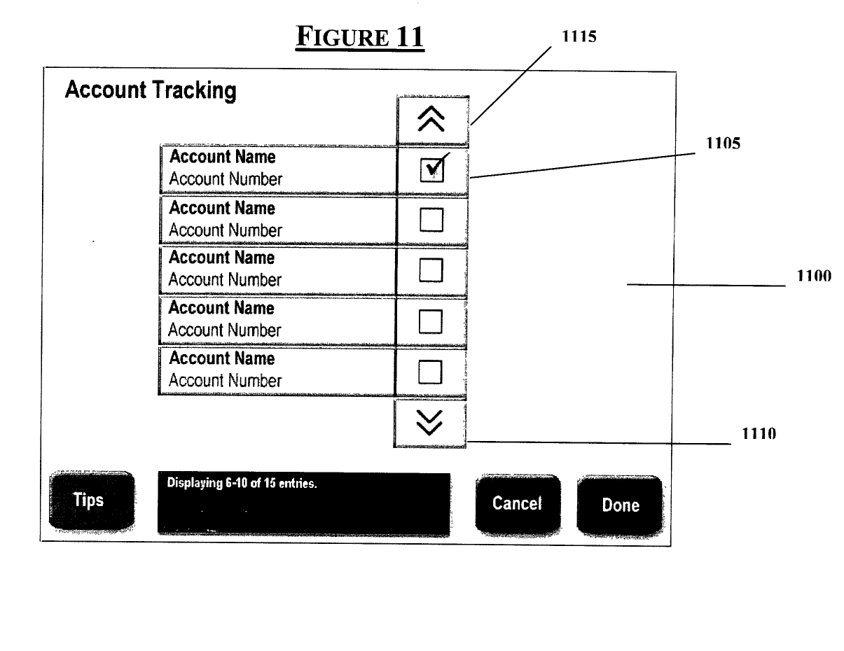

FIG. 11 illustrates an account tracking feature for one embodiment of the present invention. Display 1100 presents the user with accounts to which a particular job, such as a copy job, may be charged. A plurality of account options may be configured by a system administrator. The user selection of a particular account is acknowledged by the interface and visually indicated by the presence of the check sign in graphical object 1105. Graphical object 1105 functions as a radio button if a job may be charged to only one account or as a check box if the job may be charged to multiple accounts. The account information recorded by the interface may be logged and available for reproduction in report format.

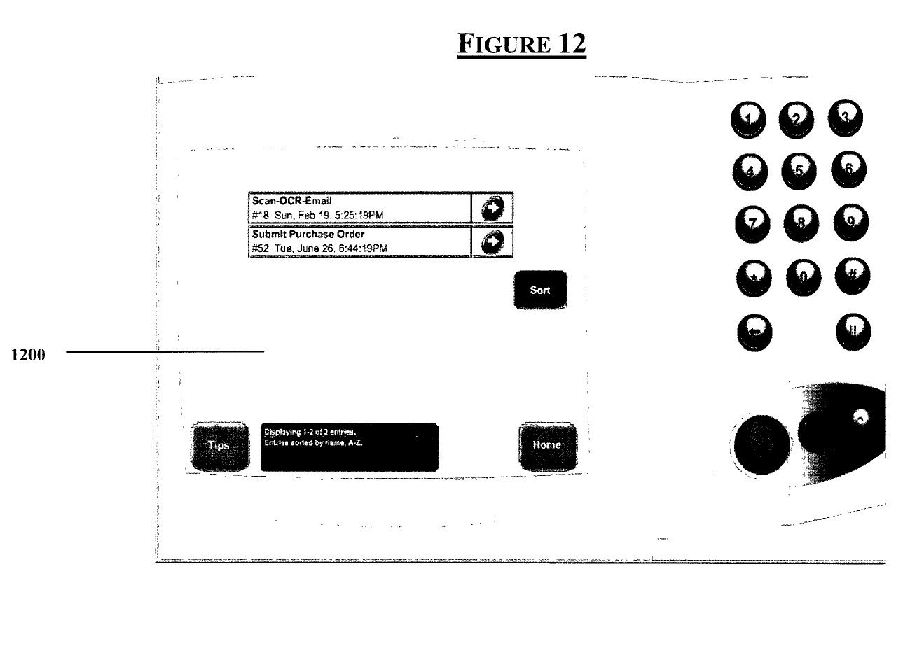

FIG. 12 illustrates a display screen 1200 from an embodiment that is accessed upon user selection of the Profiles icon 130. The Profiles feature can allow the user to cause the multifunction device to accept a default set of control parameters associated with a particular type of operation.

One embodiment of the present invention also includes a code update feature that is not linked to any one set of the hierarchal displays of graphical objects described by way of exemplary embodiments in the preceding paragraphs. As technology evolves it may be desirable for the code or instruction sets executed by the system processor to become updated to allow more robust functionality. Therefore, such an embodiment could accept updates to the code or instruction set with which it is initially deployed.

All possible display screens displaying the complete hierarchy of display screens or navigational paths are not depicted in the present figures. Therefore, the figures presented should be viewed as illustrative and not limiting. Furthermore, the characterization of certain operations as “basic” and others as “advanced” or complex should be seen as illustrative only and not limiting of the particular hierarchy in which user interface screens are presented or navigated. Usability tests may indicate that a particular group of users are best served by an interface that presents a different progression of control options than is presented in the specification and Figures. Those in the art will appreciate that the present invention may be used with any particular order of device operations or interface screen hierarchy.

The embodiments described above are given as illustrative examples only. It will be readily appreciated by those skilled in the art that many deviations may be made from the specific embodiments disclosed in this specification without departing from the invention. Accordingly, the scope of the invention is to be determined by the claims below rather than being limited to the specifically described embodiments above.

What is claimed is:

1. A graphical interface system for controlling a multifunction device, the system comprising:
(a) a touch sensitive display capable of displaying graphical objects and capable of receiving tactile input from a multifunction device user;
(b) a system data store capable of storing one or more graphical objects and grouping information associated with them; and
(c) a system processor comprising one or more processing elements, in communication with the touch sensitive display and the system data store, wherein the system processor is programmed or adapted to perform the steps comprising:
(i) selecting a plurality of cognitively grouped graphical objects stored in the system data store, wherein the cognitively group graphical objects represent a layer within an hierarchy of cognitively grouped graphical objects;
(ii) triggering the touch sensitive display to display the selected graphical objects;
(iii) receiving a signal from the touch sensitive display indicating a location touched by a user of the multifunction device;
(iv) identifying a touched graphical object; and
(v) selectively controlling operation of the multifunction device based upon the identified graphical object.

2. The system of claim 1, wherein the system processor selectively controls operation of the multifunction device by performing step comprising of repeating steps i) through v) if the identified graphic object has an associated cognitively grouped plurality of graphical objects located within a different layer of the hierarchy, wherein the system processor selects this associated cognitively grouped plurality of graphical objects as the selected graphical objects in repeated step i).

3. The system of claim 1, wherein the graphical objects include graphical objects for navigating between a plurality of user interface display screens in a hierarchy of user interface display screens.

4. The system of claim 1, wherein at least one of the graphical objects allow the user to effect control over electronic mail operations that include creating an electronic copy of a document and transmitting the electronic copy via electronic mail.

5. The system of claim 4, wherein the graphical objects include a virtual keyboard for entering subject and message information for transmission via electronic mail.

6. The system of claim 1, wherein at least one of the graphical objects allow the user to effect control over facsimile operations that include creating an electronic copy of a document and transmitting the electronic copy via facsimile.

7. The system of claim 6, wherein the graphical objects include a virtual keyboard for entering information that will be transmitted via facsimile as a cover page.

8. The system of claim 1, wherein one of the graphical objects represents a default set of multifunction device parameters.

9. The system of claim 1, wherein one of the graphical objects represents an account tracking feature.

10. The system of claim 1, wherein the system processor changes the appearance of a graphical object in response to a user selection of the selected object.

11. The system of claim 1, wherein the system data store is further capable of storing at least one contact information record.

12. The system of claim 11, wherein the graphical objects include a virtual keyboard for manipulating contact information stored in the system data store.

13. The system of claim 11, wherein one of said graphical objects represents a shortcut feature for retrieving contact information from the system data store.

14. The system of claim 1, wherein the system data store is further capable of storing authentication information.

15. The system of claim 14, wherein the graphical objects include a virtual keyboard for manipulating authentication information stored in the system data store.

16. The system of claim 1, wherein the graphical objects include a virtual keyboard for entering or modifying textual information.

17. The system of claim 16, wherein the virtual keyboard is displayable in one of a plurality of user selectable language formats.

18. A graphical interface system for controlling a multifunction device, the system comprising
(a) display means for displaying graphical objects and receiving tactile input from a multifunction device user,
(b) data storage means for storing graphical objects and grouping information associated with them; wherein the graphical objects include graphical objects representative of a multifunction device's operations or parameters associated therewith;
(c) processing means in communication with the display means and the data storage means, for:
(i) selecting a plurality of cognitively grouped graphical objects stored in the data storage means, wherein the cognitively group graphical objects represent a layer within an hierarchy of cognitively grouped graphical objects;
(ii) triggering the display means to display the selected graphical objects;
(iii) receiving a signal from the display means indicating a location touched by a user of the multifunction device; and
(iv) identifying a touched graphical object; and
(v) selectively controlling operation of the multifunction device based upon the identified graphical object.

19. Computer readable storage media storing instructions that upon execution by a system processor cause the system processor to provide a graphical user interface for controlling a multifunction device, the media having stored instructions that cause the system processor to provide the graphical user interface by performing the steps comprising of:
(a) displaying a cognitive grouping of graphical objects on a touch sensitive screen from a system data store, wherein the displayed graphical objects include graphical objects that represent multifunction device operations for creating an electronic copy of a document and transmitting the copy by electronic mail;
(b) recognizing via a tactile input to the touch sensitive screen a user selection of a selected graphical object, wherein the selected graphical object represents multifunction device functionality for creating an electronic copy of a document and transmitting the copy by electronic mail;
(c) retrieving contact information from the system data store;
(d) transmitting a signal to a system processor in response to a user selection; and
(e) operating the multifunction device to deliver an electronic copy of a document based upon the retrieved contact information via electronic mail.

20. A method of controlling a multifunction device via a graphical user interface, the method comprising the steps of:
(a) storing one or more contact information records in a system data store;
(b) retrieving a cognitive arrangement of graphical objects and information associated with them from the system data store, wherein the retrieved graphical objects include one or more graphical objects that represent facsimile operations performable by the multifunction device;
(c) displaying the cognitive arrangement of graphical objects on a touch sensitive display screen;
(d) receiving via tactile input a user selection of at least one of the displayed one or more graphical objects that are representative of facsimile operations;
(e) retrieving a selected contact information record from the stored one or more contact information records; and
(f) causing the multifunction device to deliver a facsimile transmission based upon the selected contact information record.
